(19) United States
(12) Patent Application Publication
(10) Pub. No.: US 2020/0284539 A1
(43) Pub. Date: Sep. 10, 2020

(54) SOUND TRIGGERED FIREARM

(71) Applicants: Dorothy D Burdine, Ardmore, TN (US); Lavada Sue Pitts, Huntsville, AL (US); Robert V Burdine, Ardmore, TN (US)

(72) Inventors: Dorothy D Burdine, Ardmore, TN (US); Lavada Sue Pitts, Huntsville, AL (US); Robert V Burdine, Ardmore, TN (US)

(73) Assignee: AREA DENIAL SYSTEMS, LLC, Ardmore, TN (US)

(21) Appl. No.: 16/297,606

(22) Filed: Mar. 9, 2019

(51) Int. Cl. F41A 19/58; G10L 15/22

(52) U.S. Cl. CPC F41A 19/58; G10L 2015/223; G10L 15/22

(57) ABSTRACT

Apparatus and methods facilitating the discharge of a firearm by sound are disclosed. The present invention relates to methods and means of firing a firearm on the firearms receipt of a sound avoiding the use of a mechanical trigger facilitating the grip of the firearm not changing during the act of firing avoiding any motion by the shooter therefore improving the accuracy of the aim of the firearm. No personalization or additional security is incorporated in the firearm.

### FIELD OF THE INVENTION

Apparatus and methods facilitating the discharge of a firearm by sound are disclosed. The present invention relates to methods and means of firing a firearm on the firearms receipt of a sound avoiding the use of a mechanical trigger facilitating the grip of the firearm not changing during the act of firing avoiding any motion by the shooter therefore improving the accuracy of the aim of the firearm. No personalization or additional security is incorporated in the firearm.

### DISCUSSION OF THE PRIOR ART

Present day guns are initiated, otherwise known as fired, with a mechanical trigger. A trigger is a mechanism that actuates the firing sequence of a firearm. A small amount of energy applied to the trigger causes a chain of events that results in the release of much greater energy that is then imparted to a projectile typically known as the bullet. This action as a whole is commonly referred to as firing the gun. Although triggers usually consist of a lever actuated by the index finger, some such as the M2 Browning machine gun use the thumb, and others like the Springfield Armory M6 Scout use a “squeeze-bar trigger.”

Modern day firearms rely on a trigger mechanism, sometimes augmented with devices for rapid fire, such as in the case of military weapons, and the bump stock or similar contrivances in civilian weapons. Bump fire is the act of using the recoil of a semi-automatic firearm to fire shots in rapid succession, which simulates the ability of a fully automatic firearm sacrificing accuracy for an increase in the number of rounds fired in a given time.

Previous attempts have been made to avoid the use of a trigger to fire a firearm. No attempts have been made in current precision firearms to delete the use of a trigger. Many attempts, and significant progress, have been made to reduce the force necessary to be applied to the trigger to fire the firearm. Many vendors promote trigger mechanisms that require lower finger pressure to initiate the trigger.

So critical is the action of pulling the trigger that some manufacturers now produce a double-action/single-action (DA/SA) firearm trigger. The term “DA/SA” typically denotes a semi-automatic, while in a revolver, “double action” generally means a weapon combining the ability to fire both double- and single-action, as opposed to a plain single-action revolver.

In general terms, “double-action” refers to a gun trigger mechanism that both cocks the hammer and then releases the sear, thus performing two actions, hence double action. However, although “double action” actually refers to a gun that cocks and releases the hammer with a trigger pull, in practice, most “double action” guns feature both single- and double-action abilities. This is opposed to “DAO” or “Double Action Only” firearms, which lack the ability to fire in single-action mode.

A double set trigger accomplishes the same thing but uses two triggers. One sets the trigger and the other fires the weapon. Set triggers are most likely to be seen on customized weapons and competition rifles where a very light trigger pull is beneficial to accuracy.

The present disclosure does not require the use of a trigger to initiate the firearm. In this manner no mechanical loading of the firearm is incurred when squeezing or pulling a trigger that may distort the aim. The present invention is not a smart gun as it does not incorporate a safety feature or features that allow it to fire only when activated by an authorized shooter. Any shooter can operate the present disclosure without authorization just as any common gun.

### SUMMARY OF THE INVENTION

This invention relates to the firing of a firearm without the use of a mechanical trigger. The firearm is fired by receipt of a sound produced by the shooter. Sounds such as a whisper, a spoken word, a click, a mouth or other oral action, or any sound as designated are preferred.

In this manner the guns aim is not affected by a trigger action. This embodiment gives the present invention a distinct advantage when used in high precision activities such as long-range hunting and sniper applications.

The problem addressed by this disclosure is the elimination of shooting inaccuracy due to the mispointing of the firearm imparted by forces introduced to the firearm through the mechanical action of pulling a trigger to fire a gun. This distortion of the aim is addressed by removing the requirement for the mechanical action, the pulling of the trigger to fire the firearm.

There are several distinct actions in the pulling of a trigger. First is the Slack. This is the initial pull, or squeeze, on the trigger causing movement from where the trigger rests normally to where it Breaks, initiating the gun firing. It is widely reflected in the literature that one of the most important aspects of firing accuracy is the trigger pull. The ability to perfect this area of shooting will typically improve performance faster than any other skill. Shooters are often advised to breathe in, exhale slowly, and squeeze the trigger. A principal source of targeting error in a typical firearm is introduced during the squeezing of the trigger. Even the smoothest squeeze requires high consistency with limited side motion or twist to maintain any accuracy. There are many aspects to perfecting a proper trigger pull. One often noted is having the right grip. If the firearm is too large for the shooter the shooters hand can't exert the proper force in the proper manner to pull the trigger. If the grip on the firearm in not correct the arm and hand muscles cannot be used for their maximum control.

Once the firearm is well suited to the shooters grip, the next step is to isolate the trigger finger. The trigger finger is often preferred to be the index finger and is used exclusively for the pulling of the trigger. Shooters are often taught to concentrate on only moving the trigger finger. This is intended to isolate the trigger finger's movement from the rest of the hand so as to not interrupt sighting the target and stabilizing the firearm to maintain aim.

So delicate is the trigger pull, and so essential to maintaining correct aim, that dry firing (practice firing the weapon without ammunition), is typically recommended as a way to practice and perfect the trigger pull. Without the recoil and noise resulting from live fire, the shooter can observe any movement of the gun. The trigger must move smoothly without imparting side load on the gun until the trigger Breaks and the gun fires. Breath control is required to put the body in a repeatable configuration facilitating accuracy. Shooters often practice both dry and live fire to perfect the trigger pull. The present invention completely eliminates the trigger pull as there is no trigger.

Second is the Break where the gun actually fires. After the gun has fired the trigger motion continues to the Stop, where the trigger stops moving. The Break and the Stop positions vary widely among different guns. Another common source of error, sometimes referred to as twitching, is the anticipation of the recoil from the gun shot. This is often caused by uncontrolled or unnoticed arm or body motion when squeezing the trigger. When the trigger is released after firing, it moves to the Reset, and the gun is ready to fire again. During the course of these four points, there are numerous issues with a trigger pull that can negatively affect accuracy. Some shooters also anticipate the gun firing and this anticipation, in combination with the trigger pull concerns, often produces a flinch response just as the trigger is pulled reducing accuracy. The pulling of the trigger without flinching and pulling the trigger evenly so as not to interrupt the sight alignment requires practice, and for high accuracy, considerable skill. The present invention facilitates the shooters concentrating completely on aiming the gun, staying in the same position, gripping firmly and aiming all the way through firing the shot.

Another source of error is often caused by a lack of what is commonly known as “follow through”. There will be a definite point where the trigger Breaks. In some cases, this isn't always where the trigger will stop moving backward, in others it is. Various techniques are often prescribed including such details as finger position on the trigger. It is most often stated that practice with live fire is the best method to learn to compensate for recoil and perfect the individuals firing technique.

With the present invention, none of these issues exist. No mechanical forces are applied to the firearm to imitate firing. No contact forces of any kind are applied to the firearm to initiate firing. The body of the shooter is relaxed and the shooter firmly but comfortably grips the firearm. This grip is not modified or in transition (pulling the trigger) during the firing of the firearm removing the most common and major sources of targeting error facilitating the highest possible accuracy.

Issues with the trigger pull and grip pressure are greatly reduced or eliminated by the present invention. Holding the gun reduces to a stable operation without need for body moment of any kind.

It is a preferred embodiment of the present invention that no movement of any part of the body in contact with the firearm be required to move during the firing of the firearm thereby avoiding the introduction of aiming error.

It is a preferred embodiment of the present invention that one or more microphones or other sound sensitive device be mounted on the firearm or, alternatively, on a headset or other remote device such as a hand-held microphone or microphones, and that these devices receive the sound to fire the firearm. The shooter aims the firearm and makes a sound into the microphone and the firearm fires. It is a further preferred embodiment that the sound made by the shooter be compared to a previously recorded sound and recognized as a sound to fire the firearm, and the firearm fires. It is a further embodiment that the shooter approximately aims the firearm and initiates a time in which the fire sound can be given. This may be by means of a mechanical or other switch, or by other means, including sound, as desired. Once the firearm is initiated to receive the fire command, the shooter takes aim and initiates the firing of the firearm by making the sound required to fire. The firearm fires, then reverts to a no-fire condition where the fire command sound can no longer be received. The firearm may be configured to receive the fire command for a limited time, such as within 10 seconds, and if the fire command is not received within the time period, revert to a no-fire condition.

In the simplest version of the present invention, the sound need only be of sufficient frequency and amplitude to initiate firing. In this manner any sound may be used and the electronic requirement to compare the sound to a recorded sound is eliminated, greatly simplifying the mechanism, thereby reducing the complexity and cost of the firearm.

Alternatively, a button, or other sensor to include optical, magnetic, or contact sensor or switch of any type on the firearm is pressed, or otherwise initiated, and held by the shooter as part of the grip of the firearm during which time the shooter makes the firing sound to take the shot as desired. The button is released after the shot and the firearm returns to its no-fire condition.

A preferred method of the present invention is the use of the click sound to initiate the firearm. The technical name for a sound of this type is an unvoiced alveolar lateral click. In English speaking cultures, this sound is only used non-verbally, where it can have a variety of meanings. For example, horse-riders will use this sound to encourage their horses to start to move or speed up. The sound is also sometimes used when winking as a gesture of camaraderie with the person being winked to. Dogs are sometimes called using this sound. These click signals are typically damped oscillations and have the dominant frequency content located between 1,000 Hz and 8,000 Hz. The standard deviation of the click series of the broadband click sound level is widely reported to be between 2.2 and 4.3 db. The total duration of the click typically ranges between 2.0 ms and 10.0 ms for a 20-db decay range. Average standard deviations of 57% in rise-time and 32% in drop-time have been found. The minimum and maximum deviations in the ⅓ octave bands from 1,250 Hz to 4,000 Hz are typically less than 6 db, for 0 to 120 deg. azimuth, and for −27 to 127 deg. elevation. Such a short and distinctive sound is a preferred embodiment to initiate firing as it is easily discernable from most common background noises, both by frequency and duration, as verses longer sounds like the word “fire”.

It is an embodiment of the present invention to utilize any sound, to include speaking, such as speaking the word “fire”, as desired.

It is a preferred embodiment of the present invention to utilize any sound that can be made with tongue and mouth without the inhaling or expulsion of air with the lungs. In this manner the shooters breathing may be completely paused during the shot eliminating a source of aiming error when the firearm is held or otherwise in contact with the shooter.

It is a preferred embodiment of the present invention to utilize any sound that can be made by the shooter when the firearm is not held by or otherwise in contact with the shooter, such as when a headset or other remote microphone is utilized. When a headset is used and the gun is remotely mounted there is no possibility of movements by the shooter, including breathing, to influence the shot. In this manner, the shooter is free to move and use any sound made in any manner as desired.

As previously stated, it is a preferred embodiment of the present invention that the chosen sound to initiate firing is pre-recorded within the firearm means, then the sound made by the shooter for initiation is compared to the recorded sound to assure the proper sound has been detected by the firearm, then firing is initiated. Alternatively, it is a preferred embodiment of the present invention that a sound is evaluated by the firearm as to frequency and intensity, or by other parameters as desired, without the need for a comparison with a recorded sound. In this manner a sound frequency and intensity alone may be used to initiate the firearm. The objective is for the shooter to initiate the firearm by a sound alone without introducing mechanical stress or motion to the firearm through the pulling of a trigger. In this manner there is no requirement to pull, or the shooter otherwise manipulate, a mechanical device such as a trigger to initiate the firearm firing. The act of ‘pulling the trigger’ introduces a primary source of error in aiming precision increasing the likelihood that the target will be missed. This source of aiming inaccuracy is avoided with the present invention.

In the case of a long gun, such as a rifle, the microphone is preferably mounted on the firearm such that it is near the chin and mouth of the shooter when the gun is in the aimed position. This places the microphone near the shooter's mouth to assure ease of aim and ready reception of the audio signal by the microphone. In this manner the shooter can make the appropriate sound to fire the firearm with the head in a natural position.

In another embodiment, the microphone is mounted on a headset. The headset may be connected to the firearm by either a conductive cable or via a radio or optical connection. This is a preferred embodiment for the use of a firearm that is remotely mounted and fired.

It is a preferred embodiment of the present invention that a time window for firing be settable within a range from zero to as many seconds as desired. In this manner a start time can be initiated by the shooter with a time limit to take the shot. A ten second time window is a preferred interval of the present invention.

It is a preferred embodiment of the present invention that the shooter depresses a button as part of the standard grip of the firearm during which time the shot can be made, and when the button is released the gun reverts to a no-fire condition. In this manner a timer is not required and the shooter has more complete control of the firearm.

A microphone responds to the movement of air irrespective of what caused the air to move. This means that a microphone cannot distinguish between air movement originating from a shooter, and air movement originating from local weather. Wind noise is a common problem with microphones and should be expected in the shooting environment.

A preferred method of reducing wind noise is the attenuation of low frequencies using electronic means. Wind noise is largely comprised of low frequency sound often described as “rumble.” Limiting the extreme bass from a microphone signal is an effective method to reduce audible wind noise.

Another preferred method of reducing wind noise in the microphone is layers of metal, cloth, or plastic mesh overlaying the microphone.

The mesh takes moving wind and divides it into numerous smaller wind flows attenuating the power of the gust. The mesh is preferred to be ridged such that the mesh does not vibrate or rattle causing unwanted mechanical noise.

Open cell foam is commonly used to reduce wind noise and will act in a manner similar to the mesh but will provide even greater attenuation of the wind energy. It provides a meandering path for the air to move from the outer surface of the foam to the inner surface. To be effective, the external windscreen shape must be aerodynamic to eliminate turbulence noise as wind moves over the windscreen. The most effective windscreens that are commercially available and commonly used on microphones have multiple layers of open-cell foam, each with a different porosity.

All methods herein described and commonly employed to reduce wind noise including such items as mesh buckets and artificial fur are preferred embodiments of the present invention.

It is a preferred embodiment of the present invention to utilize one or more omnidirectional microphones as they are more resistant to wind than directional microphones. It is a further preferred embodiment of the present invention that the shooter places their mouth very near the microphone to better receive the audio command to shoot. Again, the short click is easily differentiated from wind and other noise. After the shot is made the gun reverts to a no-fire or manual fire condition.

It is a preferred embodiment of the present invention that a tilt sensor be incorporated for the detection of gun motion. For example, if the gun moves more than a predetermined amount, such as 5 degrees, after the sound trigger is initiated the gun reverts to trigger mode or disarms, resulting in a no fire condition. In this manner the gun cannot be dropped or substantially redirected while still armed to fire.

It is a preferred embodiment that the gun be activated or deactivated solely by the condition of an authorizing button. When the button is depressed the gun will fire when the proper signal is received, and when the button is released the gun will revert to a no-fire condition.

It is a preferred embodiment that the gun be activated or deactivated solely by the condition of an authorizing button. When the button is depressed the gun will fire when the trigger is pulled and when the button is released the gun will revert to a no-fire condition. This facilitates the typical manner of using a firearm as a trigger-initiated device.

It is a preferred embodiment that upon the firearm firing the microphone is shut down, by being disconnected, shorted, or electrically loaded after fire initiation, avoiding damage from the intense noise and vibration generated by the gun. Preferred methods include removing the electrical connection (disconnecting the microphone), shorting the microphone, or applying voltage to load the microphone thereby pulling the diaphragm to a safe position. In typical use a microphone must withstand a maximum signal level of 180 db or more repeatedly, while still being sensitive to as little as a 10 db signal. The preferred microphone will not be damaged by repeated exposure to the noise of the gun.

In the case where the microphone is mounted on a headset or otherwise on the shooter and connected to the firearm, the head is facilitated to be in any position. Such a headset may incorporate hearing protection. A headset allows the head to be in any position as preferred in reference to the gun with no concern for microphone alignment.

Once the fire command is initiated, a countdown timer starts defining a time in which the gun may be fired. The countdown timer may be indicated to the shooter by audio means such as a one second beep or continuous sound, or visually as by an LED display or an LED countdown indicator, or other means as preferred by the specific application. It is a preferred embodiment that the countdown timer makes no indication to the shooter.

Unless otherwise defined, all terms (including trade, technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art, and should not be interpreted in an idealized or overly formal sense unless expressly so defined herein. Well known functions or constructions may not be described in detail for brevity and/or clarity. The terms gun and firearm are used interchangeably.

### BRIEF DESCRIPTION OF THE DRAWINGS

The invention will now be described with reference to the accompanying drawings in which:

FIG. 1 illustrates the principal components of the present invention. It is comprised of the individual components including a Firearm 1, a Microphone 2, a Fire/Record Select Switch 3, a Headset Microphone/Fire Command Jack 4, a Remote Microphone/Fire Command Radio Link 5, a Fire Button 13, an Optical Receiver 16, and a Change of Position Detector 17.

FIG. 2 illustrates the principal components of the present invention. It is comprised of the individual components including a Firearm 1, a Microphone 2, a Fire/Record Select Switch 3, a Headset Microphone/Fire Command Jack 4, a Remote Microphone/Fire Command Radio Link 5, a Manual Trigger 6, a Fire Button 13, an Optical Receiver 16, and a Change of Position Detector 17.

FIG. 3 illustrates a Headset 12 comprised of Frame 7, Headset Microphone 8, Connector 9, Radio/Interface 10, Ear Protection 11, Command To Fire 14, and an Optical Transmitter 15.

FIG. 4 illustrates a handgun comprised of the individual components including a Firearm 1, Trigger 6, a Microphone 2, a Fire/Record Select Switch 3, Headset Microphone/Fire Command Jack 4, Remote Microphone/Fire Command Radio Link 5, a Fire Button 13, an Optical Receiver 16, and a Change of Position Detector 17.

FIG. 5 illustrates a high-level logic flow of a Microphone 2 initiated firing system.

### DETAILED DESCRIPTION OF THE INVENTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In regard to the following description of the Figures, the terms and their preferred embodiments follow.

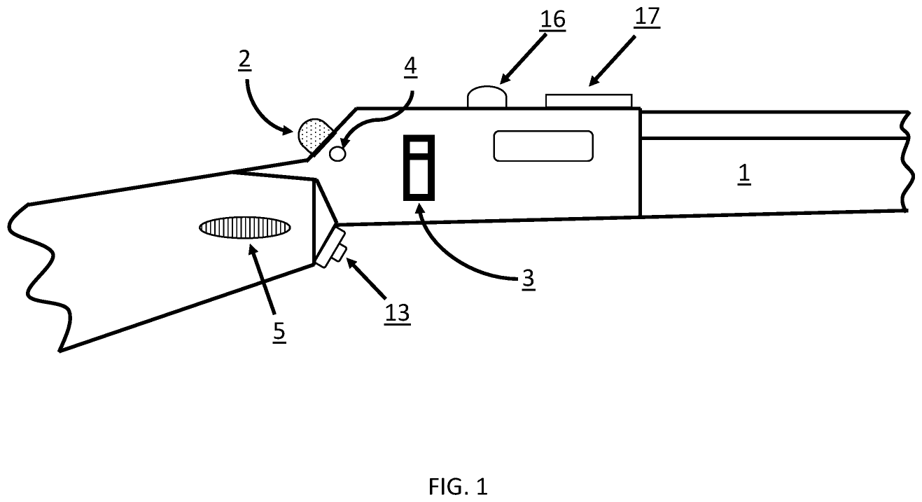

FIG. 1 illustrates the principal components of the present invention. The term Firearm 1 refers to a firearm of any type to include all rifles, handguns, specialty and military firearms. Firearms are typically those that throw a projectile using compressed gas, though other methods and means are possible and are included in the present disclosure. It is comprised of a stock, body and barrel, a Microphone 2, placed in a position near the mouth of the shooter when the firearm is held in the typical shooting orientation, a Fire/Record Select Switch 3, Headset Microphone/Fire Command Jack 4, Remote Microphone/Fire Command Radio Link 5, Fire Button 13, an Optical Receiver 16, and a Change of Position Detector 17.

The Microphone 2 is any type of device that can receive a sound or pressure wave of any type and frequency and produce a signal.

The Fire/Record Select Switch 3 is a three or more position switch. In one position the Firearm 1 is selected to be in a fire mode, in particular in a mode to receive a signal from Microphone 2, compare that signal to a stored signal such as a sound, and if the signals match within a predetermined manner fires the Firearm 1. In the Record position it allows a sound received by Microphone 1 to be received and stored for future comparison. An off position is provided to support various implementations of the present invention.

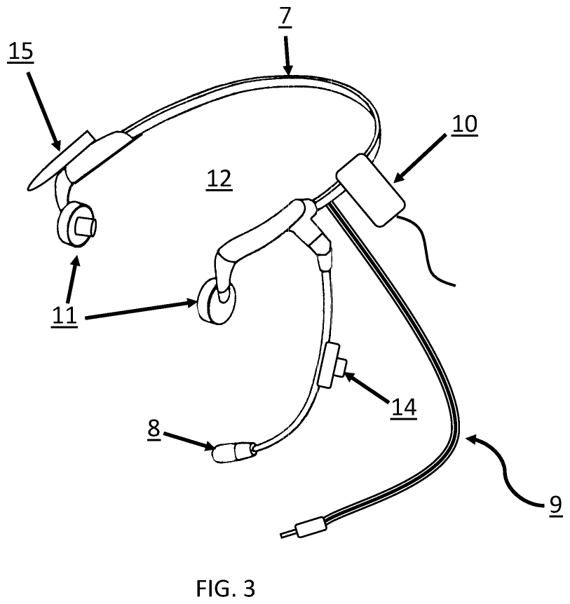

The firearm incorporates means to record the sound command to fire the gun as generated by the shooter through Microphone 2. The Fire/Record Select Switch 3 is preferred as a three or more position switch to include an off position. The Fire/Record Select Switch 3 is set to Record and the shooter speaks the sound to fire the gun into Microphone 2. This sound is recorded and stored within the electronics of the gun (not shown). When the shooter is ready to fire, the Fire/Record Select Switch 3 is set to Fire. The time that the Fire/Record Select Switch 3 remains in the Fire position is preferred to be limited to a few seconds, and 10 seconds is a preferred embodiment. If no command to Fire is given by the shooter within the time allotted (the 10 seconds) the gun reverts to a no-fire condition. Within the time allotted, the shooter aims the weapon and when ready makes the fire sound into the Microphone 2. This sound is then compared by the electronics (not shown) to the sound made by the shooter during recording. If these sounds are matching within prescribed constraints the gun will fire the round. If they do not the gun will not fire. All of the recording and fire command activities and actions may also be accomplished through the use of a Headset 12 as shown in FIG. 3 through Headset Microphone/Fire Command Jack 4, and/or Remote Microphone/Fire Command Radio Link 5. All inputs of the command to fire from the various devices are through the Headset Microphone/Fire Command Jack 4, the Remote Microphone/Fire Command Radio Link 5, or the Optical Transmitter 15 and the Optical Receiver 16.

A preferred embodiment of the present invention that is a simpler alternative to comparing a recorded sound to a command to fire sound is to simply fire when the Microphone 2 receives a sound within the given time as initiated by the Fire/Record Select Switch 3 that is within the predetermined frequency range, duration and amplitude. For example, a preferred method of the present invention is the use of the click sound to initiate the firearm. The technical name for a sound of this type is an unvoiced alveolar lateral click as previously stated. This click is within a consistent frequency range, duration and amplitude for almost all persons as previously stated. A circuit to interpret the sound signal and initiate firing is preferred to be a Band Pass filter comprised of capacitors, resistors, and coils or their circuit equivalents. In this manner the Fire/Record Select Switch 3 is not used or required to be incorporated into the firearm.

A preferred embodiment of the present invention is the use of an Optical Receiver 16. The Optical Transmitter 15 mounted on Headset 12 (FIG. 3) transmits a command to fire via an optical signal to Optical Receiver 16. This action may be initiated by pressing Fire Button 13.

The Fire/Record Select Switch 3 is selected in the fire position. In this manner no sound is made by the shooter to fire the weapon.

The Level 17 detects the vertical angle of the Firearm 1. The orientation of the Firearm 1 in terms of the vertical angle is compared to the preset of Level 17, and a signal from Level 17 is returned indicating that the Firearm 1 is or is not within the allowed vertical angle limits. When the Fire/Record Select Switch 3 is in the Fire position, and/or the Fire Button 13 is pressed depending on the desired operation of the Firearm 1, the Level 17 detects the current vertical orientation of Firearm 1 and allows or disallows operation of Firearm 1. If the vertical orientation of Firearm 1 changes by an amount preset by the manufacturer, or set by a user determined amount, the Level 1 signal prevents firing of the Firearm 1 and reverts Firearm 1 to a no-fire condition. In this manner the Firearm 1 cannot inadvertently fire when the gun is lowered or holstered, preventing accidents.

The allowed angle and the limits of that angle at which Firearm 1 may be operated are either preset by the manufacturer or set by the user. For example, if the Firearm 1 is to be used to fire on a target, and the target will be within plus or minus 10 degrees of 5 degrees above the horizontal, the Level 17 limits are set to plus 15 degrees, and minus 5 degrees, then the shooter takes aim, the Firearm 1 is pointed at 5 degrees above the horizontal, and the shot can be made. If the Firearm 1 is lowered or raised outside of its 20 degree allowed vertical range the Firearm 1 reverts to a no fire condition.

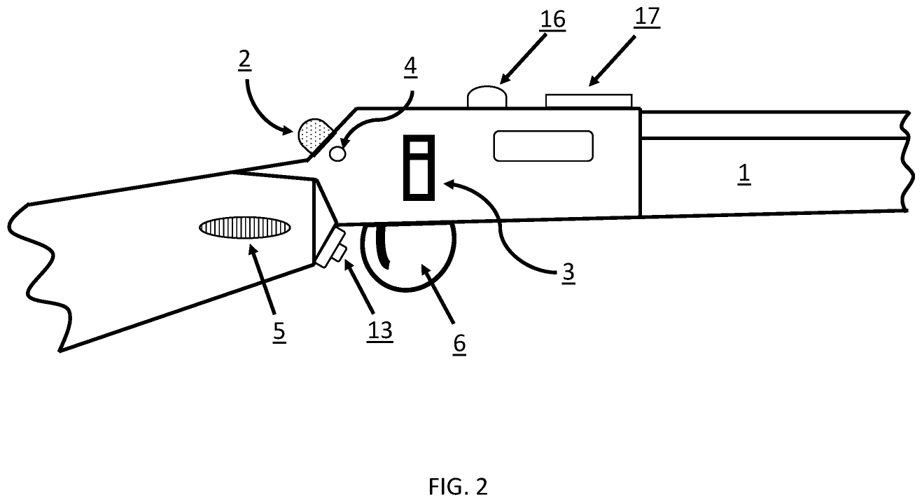

FIG. 2 illustrates the principal components of the present invention. It is comprised of the individual components including a Firearm 1, comprised of a stock, body and barrel, but in this case a trigger is provided, Trigger 6. A Microphone 2 is provided and normally placed in a position near the mouth of the shooter when the firearm is held in a shooting orientation, a Fire/Record Select Switch 3, Headset Microphone/Fire Command Jack 4, Remote Microphone/Fire Command Radio Link 5, Optical Receiver 16, a Change of Position Detector Safety 17, and a Fire Button 13.

Manual Trigger 6 is a squeezable trigger to initiate firing of Firearm 1. It requires Fire Button 13 to be depressed and optionally the Fire/Record Select Switch 3 to be in the Fire or off positions as desired for the particular firearm and its preferred function.

In this case the gun may be fired as a regular firearm by depressing the Fire Button 13 and using the Trigger 6, or when the Fire/Record Select Switch 3 is in the Fire position, respond to the sound received through Microphone 2 as in the FIG. 1 explanation. In this manner the firearm may act both as a somewhat regular firearm with the ability to become a high accuracy firearm eliminating any inaccuracy introduced by the Trigger 6 as desired.

A preferred embodiment of the present invention that is a simpler alternative to comparing a recorded sound to a command to fire sound is to simply fire when the Microphone 2 receives a sound within the given the time as initiated by the Fire/Record Select Switch 3 that is within a predetermined frequency range, duration and amplitude as previously discussed.

A preferred embodiment of the present invention is the use of Fire Button 13. The Fire Button 13 is located on the firearm such that it is easily depressed during the normal grip. When Fire Button 13 is pressed by the shooter it allows the manual operation of Trigger 6 to fire Firearm 1. When Fire Button 13 is pressed and held the Firearm 1 is preferred to operate much as a standard firearm in that pulling Trigger 6 will cause Firearm 1 to fire. Fire Button 13 is preferred to be operable as a function of the natural grip of the firearm as desired. The Fire Button 13 is preferred to be a momentary plunger snap action pushbutton that is normally open, or equivalent, conducting electricity in the depressed position. While the Fire Button 13 is depressed the gun is placed into a fire condition and may fire immediately, or upon receipt of the sound signal to fire, or by comparison to a prerecorded sound signal, or to a sound level and duration/frequency, being received by Headset Microphone 8. In this manner the Fire/Record Select Switch 3 is not used or required to be incorporated into the firearm.

FIG. 3. Illustrates the Headset 12, comprised of Headset Microphone 8, Headset Microphone Line 9, Remote Microphone/Fire Command Radio Transmitter 10, Headset retainer 7, Command To Fire 14, Optical Transmitter 15 and Earpieces 11.

Headset Microphone/Fire Command Jack 4 is a wired connection to Headset 12 providing a conduction path for sending and receiving signals to and from the Firearm 1.

Remote Microphone/Fire Command Radio Link 5 is a radio wave communications link between the Firearm 1 and the Headset 12. When it is connected functions on the Firearm 1 such as the Microphone 2 and others as required are disabled and the Headset 12 provides these functions.

Frame 7 is the headset frame for Headset 12. It is preferred to be suitable for holding the mechanisms it supports firmly but comfortably on a person's head.

Radio/Interface 10 is the Headset 12 radio communications link to the Firearm 1 via Remote Microphone/Fire Command Radio Link 5. It is a radio wave communications link between the Firearm 1 and the Headset 12. This link may be one way or bi-directional as required for the particular implementation of the present disclosure.

Command To Fire 14 button is mounted on Headset 12, and when pressed by the shooter issues a command to Firearm 1 to fire. This command is sent by either or all of the connections between the Headset 12 and the Firearm 1 as preferred for the particular application of the present invention. This signal may be sent by Connector 9 through Headset Microphone/Fire Command Jack 4, or by Optical Transmitter 15 and received by Optical Receiver 16, or sent and received by Radio/Interface 10 and Remote Microphone/Fire Command Radio Link 5. In this manner no sound is made by the shooter to fire the weapon. The Fire/Record Select Switch 3 is optionally required to be incorporated into the firearm and, if it is incorporated, is preferred to be set to the Fire position.

Optical Transmitter 15 is mounted on Headset 12 and transmits a signal to Optical Receiver 16 on the Firearm 1 when the Command To Fire 14 is pressed, or other action is made such as speaking into Headset Microphone 8. When the signal is received the Firearm 1 may be made to fire as per the particular configuration as desired.

Ear Protection 11 provides hearing protection to the wearer of Headset 12.

Headset 12 incorporates functions and embodiments to operate Firearm 1 both when the shooter is holding Firearm 1 and remotely, when the Firearm 1 and the shooter are separated and the shooter is not holding Firearm 1. Independent power (not shown), such as batteries, are incorporated into Headset 12 as required for the preferred application.

Headset Microphone 8 performs the same function as Microphone 2, and is any type of device that can receive a sound or pressure wave of any type and frequency and produce a signal.

Connector 9 is a cable of the desired length and physical characteristics to connect Headset 12 to Firearm 1 via any means as desired. A preferred means is electrical and mechanical. Connector 9 provides electrical power to Headset 12 from Firearm 1 and sends and receives signals as per the desired implementation of the present invention.

The Headset 12 is placed over the head of the shooter, and Headset Microphone Line 9 is plugged into Headset Microphone/Fire Command Jack 4 on the gun. When this happens, the firearm mounted Microphone 2 is made inoperable and is functionally replaced by Headset Microphone 8. Alternatively, Remote Microphone/Fire Command Radio Link 5 and Remote Microphone/Fire Command Radio Transmitter 10 may be activated and the shooter actually be situated some distance from the gun. In this manner a trainer could be employed with a beginner shooter or other positions and operations could be conducted that required the shooter and the gun to be separated. Optionally the Optical Transmitter 15 and Optical Receiver 16 may be used to also accomplish this task without radio transmission.

Earpieces 11 are preferred to attenuate the shot noise to protect the shooters ears and may incorporate communication devices, ear plugs or ear plug retainers as desired.

It is a preferred embodiment of the present invention that, using the Headset Microphone Line 9, and Remote Microphone/Fire Command Radio Transmitter 10 or Headset Microphone Line 9, a communications link is remotely established with the weapon, the weapon may be remotely mounted and fired from a distance, with the shooter not in close proximity or in contact with the weapon. The weapon may be mounted on a tripod or other support or mount and precisely aimed at the desired target. The shooter then gives the command to fire and the weapon fires. In this manner the shooter is not exposed and the weapon may be fully operational at a distance.

A preferred embodiment of the present invention is the use of an Optical Receiver 16. The Optical Transmitter 15 mounted on Headset 12 transmits a command to fire via an optical signal to Optical Receiver 16. This action may be initiated by pressing the Command To Fire 14 button. In this manner no sound is made by the shooter to fire the weapon. In this manner the Fire/Record Select Switch 3 is optionally required to be incorporated into the firearm.

It is a preferred embodiment that the Headset 12 incorporate an Optical Command 15 that transmits an optical command to Optical Receiver 16 mounted on the weapon. In this manner the command to fire may not be jammed by radio interference.

It is a preferred embodiment that the Headset 12 incorporate a Command To Fire 14 button that when pressed issues the fire command to the weapon. In this manner the need to speak a fire command is eliminated and the shooter is completely silent.

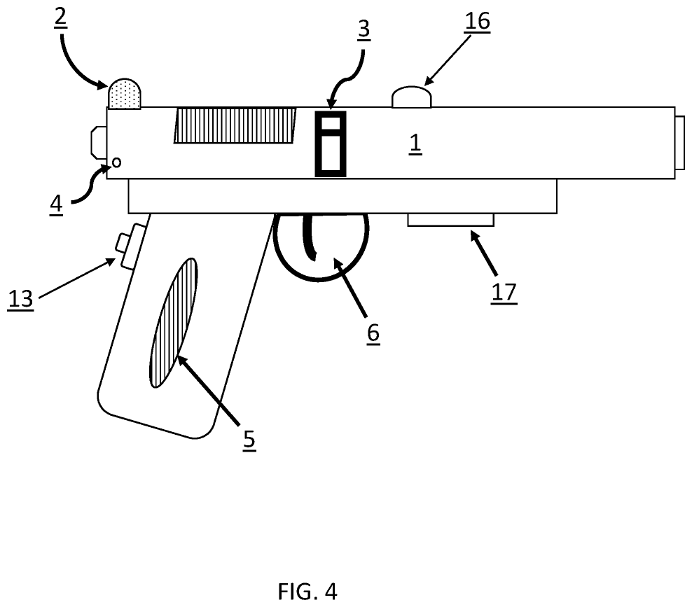

FIG. 4 illustrates the principal components of the present invention when applied to a handgun or other firearm not suitable for shouldering. It is comprised of the individual components including a Firearm 1, comprised of a grip, body and barrel, and in this case an optional trigger is provided, Trigger 6, a Microphone 2, a Fire/Record Select Switch 3, Headset Microphone/Fire Command Jack 4, Remote Microphone/Fire Command Radio Link 5, Optical Receiver 16, and a Fire Button 13.

In this case the gun may be fired as a regular firearm using the trigger, and when the Fire/Record Select Switch 3 is in the Fire position, respond to the sound received through Microphone 2 as in the FIG. 1 explanation. In this manner the firearm may act as a regular firearm with the ability to become a high accuracy firearm eliminating any inaccuracy introduced by a trigger being pulled.

A preferred embodiment of the present invention is the use of Fire Button 13. The Fire Button 13 is located on the grip of the pistol shown such that it is easily depressed during the normal gripping of the firearm. While the Fire Button 13 is depressed the gun is placed into a fire condition and may be fired upon receipt of the sound signal to fire or when the trigger is pulled. In this manner the Fire/Record Select Switch 3 is not used or required to be incorporated into the firearm.

A preferred embodiment of the present invention is the use of an Optical Receiver 16. The Optical Transmitter 15 mounted on Headset 12 transmits a command to fire via an optical signal to Optical Receiver 16. This action may be initiated by pressing Fire Button 13 or by making a pre-recorded sound into Headset Microphone 8. In this manner no sound is made by the shooter and to fire the weapon. In this manner the Fire/Record Select Switch 3 is optionally required to be incorporated into the firearm.

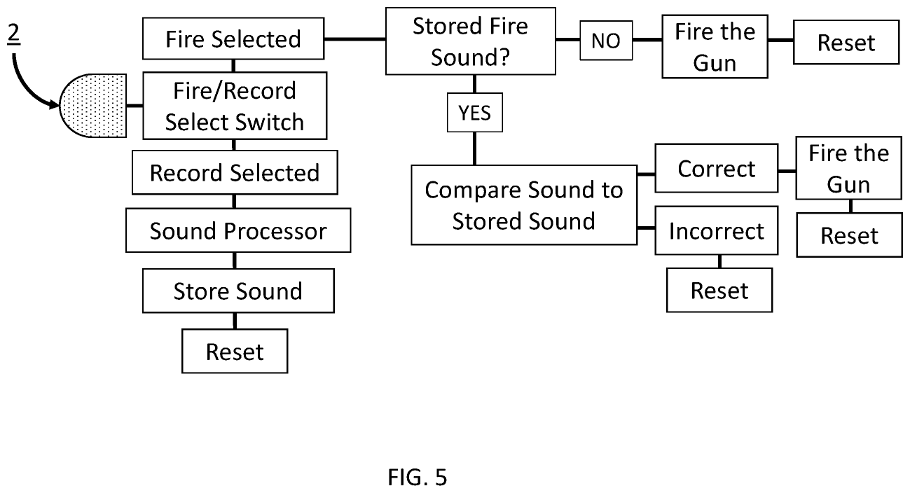

FIG. 5 illustrates a high-level logic flow for a sound-controlled firing and recording sequence. When the Fire/Record Select Switch 3 is in the Record position, the sound made into Microphone 2 is recorded and stored. When the Fire/Record Select Switch 3 is set to the Fire position, the sound made into Microphone 2 is compared to the stored sound. If the sounds match within the prescribed parameters the gun fires, and if not within the prescribed parameters the gun resets. If there is no stored sound the gun will fire and then reset.

Unless otherwise defined, all terms (including trade, technical and scientific terms) used herein have the same meaning as commonly understood by one of ordinary skill in the art to which this invention belongs. The terms gun and firearm are used interchangeably both in the singular and plural forms. It is further understood that terms, such as those defined in commonly used dictionaries, should be interpreted as having a meaning that is consistent with their meaning in the context of the specification and relevant art, and should not be interpreted in an idealized or overly formal sense unless expressly so defined herein. Well known functions and common constructions are not described for brevity.

We claim:

1. The method of a firearm configured with means to initiate the firing of a round or rounds upon receipt of an audio signal further comprising; a firearm having a frame with a handle, a barrel carried by said frame, and an audio initiated firing system initiating the discharge of a bullet through said barrel; an audio discharge initiation system being comprised of one or more microphones positioned either on or remotely from the firearm to receive an audio signal, said audio signal being generated by the shooter; means for recording and storing an audio signal, said audio signal being generated by the shooter and recorded by one or more Microphones positioned to receive an audio signal; means to compare the recorded audio signal to an audio signal received by a microphone, received either locally at the firearm or remotely via a communication signal, and discharging the firearm upon the audio signals matching within predefined parameters.

2. The method of claim 1 further comprising the firearm discharge further controlled by a tilt sensor.

3. The method of claim 1 further comprising the firearm discharge further controlled by a fire control button.

4. The method of claim 1 further comprising a countdown timer controlling the selectable period in which the firearm can be discharged.

5. The method of claim 1 further comprising discharging the firearm upon receipt of the signal of an unvoiced alveolar lateral click sound made by the shooter.

6. The method of claim 1 further comprising means of a remotely located headset facilitating a microphone further facilitating the attached or remote control of the discharge of the firearm; a communication system between a remote microphone and the firearm; the communication system signal being transmitted and received by either electrical, electromagnetic, radio, optical, or any combination thereof.

7. The method of claim 1 further comprising the firearm receiving an audio signal; comparing the received audio signal to the recorded audio signal; the audio signals not matching and the gun reverting to an initial condition;

8. The method of claim 1 further comprising the firearm receiving an audio signal; comparing the received audio signal to the recorded audio signal; the audio signals matching and the gun firing.

9. The method of claim 1 further receiving an audio signal of a determined frequency and amplitude to include a human produced audio signal and firing upon receipt of the audio signal.

10. The method of claim 1 further a trigger firing the firearm after initiation of the Fire button.

11. The method of claim 1 further comprising a trigger allowing the firing of the firearm within a predetermined time after initiation of the Fire Button.

12. The method of claim 1 further comprising upon the firearm firing the shot the firearm reverts to a no-fire or manual fire condition.

13. The method of claim 1 further comprising that the firearm be activated or deactivated solely by the condition of an authorizing button.

14. The process of a firearm configured with means to initiate the firing of a round or rounds upon receipt of a signal; one or more Microphones receiving an audio signal; a Fire/Record Select Switch selected for the recording of an audio signal; the audio signal being compared to a recorded signal; the received audio signal matching the recorded audio signal; the receiving audio microphone going into safe mode; the firearm discharging.

15. The process of a remote firearm communication and control comprising: a firearm configured with means to initiate the firing of a round or rounds upon receipt of a predetermined signal; the signal sent to the firearm by a cable connection, a radio or an optical communication; the firearm receiving the predetermined signal and discharging the firearm.
